(19) United States
(12) Patent Application Publication
(10) Pub. No.: US 2007/0280398 A1
(43) Pub. Date: Dec. 6, 2007

(54) Modified electrodes for low energy nuclear reaction power generators

(76) Inventors: Irving I. Dardik, Califon, NJ (US); Raymond G. Thompson, Birmingham, AL (US); Shaul L. Lesin, Meitar (IL); Ehud Greenspan, Emeryville, CA (US); Michael C. McKubre, Menlo Park, CA (US)

Correspondence Address: Attn: John R. Wahl;GRENBERG TRAURIG, LLP, 1750 Tysons Boulevard, 12th Floor, McLean, VA, 22102, US

(21) Appl. No.: 11/634,485

(22) Filed: Dec. 5, 2006

Related U.S. Application Data
(60) Provisional application No. 60/742,622, filed on Dec. 5, 2005.

(51) Int. Cl. G21B 1/00

(52) U.S. Cl. 376/100

(57) ABSTRACT

A low energy nuclear reaction power generator in which hydrogenous atoms are driven to increase atom-packing in a lattice and to increase the flux of hydrogenous atoms. An electrolytic cell is provided containing an anode-cathode electrode pair and an electrically-conductive electrolyte. Modifying substances, such as diamond, diamond-like, boron, beryllium, and/or carbon-based constituents, may be grown in and/or on the electrodes for enhancing the nuclear reactions. Applied across these electrodes may be a train of electrical packets, each comprised of a cluster of pulses. The amplitude and duration of each pulse, the duration of intervals between pulses, and the duration of intervals between successive packets in the train are in a predetermined pattern in accordance with superwaving waves in which each wave is modulated by waves of different frequency.

This application claims the benefit of U.S. provisional patent application No. 60/742,622, filed Dec. 5, 2005, which is hereby incorporated by reference herein in its entirety.

### BACKGROUND OF THE INVENTION

This invention relates generally to the use of electrolytic cells for the creation of low energy nuclear reaction (LENR) which generates heat.

The quest for nuclear reaction to provide an inexhaustible, non-polluting source of energy seeks to exploit the phenomena of nuclear physics. It is known that when two nuclei, for example, of deuterium (heavy hydrogen), react together, the combined mass of the reaction product is less, by a minute quantity, than the mass of the original particles. The tiny mass difference is converted to kinetic energy of the reaction products and this kinetic energy is converted to heat energy. The amount of this energy, as expressed in the classic Einstein equation, is equal to mass difference multiplied by the square of the speed of light; hence the minute mass difference yields an enormous amount of energy.

Deuterons are positively charged nuclei and, therefore, repel each other. The closer deuterons approach each other, the stronger their repulsion and the greater the energy it takes to overcome this repulsion. It is only when the deuterons are brought to one ten-trillionth of a centimeter next to each other, that a strong nuclear force that attracts nuclei overcomes the Coulomb repulsion force and the nuclei then react. This is the same nuclear force that prevents nuclei, all of which having positively-charged protons, from flying apart. Reaction also occurs between tritium and deuterium nuclei, the tritium being a heavy isotope of hydrogen, but its nucleus has a proton and two neutrons, whereas a deuterium nucleus has a proton and a single neutron.

Thermonuclear reaction will occur when deuterons are held at a high enough density and a high enough temperature for a time period sufficient to effect reaction. The center of the sun affords conditions conducive to thermonuclear reaction, for this fiery star is at a temperature of about 10 million degrees Fahrenheit. At this temperature, matter is ionized, that is, it is in a plasma state. The solar plasma ions are subjected to enormous gravitational forces that keep the ions together at a very high density, that is, at close proximity to each other. At these conditions, the thermal motion of the hydrogen nuclei is sufficient to occasionally overcome the Coulomb barrier, thus enabling two hydrogen nuclei to undergo a nuclear reaction. On earth, the gravitational forces are much weaker and cannot contain high temperature plasma. Hence, since the middle of the twentieth Century, scientists have been developing special devices that could ionize deuterium or deuterium and tritium and that contain the resulting plasma at sufficiently high density, temperature, and length of time to bring about thermonuclear reaction. Two general approaches for doing so are being pursued: magnetic confinement; and inertial confinement. As the density of the plasma ions that can be confined by magnetic fields in a practical device is very low, it takes a much higher temperature, in the order of 100 million degrees Fahrenheit, to produce a deuterium-tritium (D-T) reaction. The D-T thermonuclear reaction is the one currently being pursued, for higher temperatures are required for D-D thermonuclear reaction. Inertial confinement can compress matter to form a very high density plasma but only for a very short time. It takes a very high temperature, on the order of 100 million degrees Fahrenheit, to produce a deuterium-tritium (D-T) reaction.

Following Edward Teller's invention of the hydrogen bomb, billions of dollars have been spent over the last 50 years toward contriving devices adapted to force heavy hydrogen nuclei to react together under controlled conditions and thereby liberate more energy than was expended to confine and heat the nuclei. One such device of enormous size is known as a tokamak within whose toroidal interior powerful magnetic fields confine and squeeze hot plasma, causing deuterium and tritium ions to react together.

Tokamaks overcome the Coulomb barrier by first heating the deuterium and tritium atoms to high enough temperatures that will rip off their electrons to create a gas of ions or plasma, and then by heating the plasma to extremely high temperatures so that two plasma ions can collide at sufficiently high velocity to overcome the Coulomb barrier. Huge magnets produce the magnetic fields to hold the plasma together for a time sufficient for some of the nuclei to crash into each other and react. This thermonuclear reaction produces helium nuclei as well as neutrons and excess energy.

In a super-giant laser reaction generator, laser beams bombard a deuterium-tritium fuel pellet, causing its outer layer to vaporize and be ejected outwardly from the pellet. The resultant reaction force implodes the fuel, bringing it to very high densities and temperatures for a small fraction of a second. Under these so called “inertial confinement conditions,” deuterium and tritium nuclei can react. Yet, despite the multi-billion dollar investments made in developing thermonuclear reactors based on either magnetic confinement or inertial confinement, no such reactor is at present a practical reality, and whether it ever will be, cannot be forecast. Other technologically simpler and less expensive techniques for reacting nuclei are desirable.

In the past decade or so, electrochemical and other techniques have been investigated as a possible technique for reacting nuclei for power generation. The investigations typically utilize an electrolytic cell whose electrolyte is heavy water (i.e., water in which deuterium takes the place of ordinary hydrogen). The heavy water is rendered electrically conductive by a salt dissolved therein (e.g., lithium deuteroxide (LiOD)). Immersed in this electrolyte is an anode-cathode electrode pair composed of a strip or wire made of metal (e.g., palladium) surrounded by a coil or a foil of a similar or another metal (e.g., platinum).

When a d-c voltage is impressed across these electrodes, the resultant current flow in the electrolyte causes the water to dissociate into its constituent elements. As a consequence, oxygen is released as a gas at the platinum anode, while deuterium ions migrate toward the palladium cathode. Consequently, deuterium atoms diffuse into the palladium metal. The buildup of a large concentration of deuterium atoms in the palladium metal is thought to initiate a low energy nuclear reaction. The energy released by such a low energy reaction could be captured by the atomic lattice of the cathode and show up as heat.

A multitude of electrode designs have been put forth to stimulate nuclear energy production through the creation of various forms of hydrogen from various electrolytes and their interaction within the electrode. Various treatments have been put forth to create electrodes as previously described. However, one such treatment which has not been put forth previously is the use of in-situ diamond, diamond-like, boron, beryllium, and carbon-based constituents formed in or on such electrodes to trap various forms of hydrogen and stimulate energy producing nuclear reactions, also referred to as low energy nuclear reactions (LENR).

In 1989, Martin Fleischmann and Stanley Pons, on observing excess heat generation in an electrochemical cell, claimed they had observed evidence of a low energy nuclear reaction of deuterium ions. Further electrochemistry studies by T. Mizuno, G. H. Miley and others, suggest that other low energy nuclear reactions may take place in the solid electrode. The excess heat generation may be attributed to the reaction of isotopes of hydrogen nuclei with the nuclei of the solid electrode material rather than of the reaction of hydrogenous nuclei (i.e., nuclei of isotopes of hydrogen, such as deuterium and tritium) themselves. As a result of these nuclear reactions, the nuclei of the target material are converted or transmuted into nuclei of other isotopes. Due to mass difference between the transmutation products and between the nucleus of the metal plus hydrogenous nucleus, excess energy is generated as well.

In any case, present day LENR generator cells do not generate enough excess heat to be commercially viable power sources. Further improvements in these cell designs and methods of operation are desirable.

### SUMMARY OF THE INVENTION

It is therefore an object of the invention to provide a low energy nuclear reaction (LENR—also referred to as a condensed matter nuclear reaction) power generator that includes a cell having a pair of electrodes immersed in an electrically-conductive electrolyte, wherein at least one modifying substance, such as in-situ diamond, diamond-like, boron, beryllium, and/or carbon-based constituents, is grown or deposited into and/or on the material of the cathode electrode for enhancing the interaction between the material and hydrogenous atoms for useful energy producing reactions.

The electrodes of the invention may be any conductive material such as metal, alloy, cermet, conductive polymer, composite or any combination thereof, for example. The electrodes may be a homogeneous material or nonhomogeneous material, such as a material layered, coated, or laced with particles. The electrodes may be shaped as plates, strips, wires, spheres, squares, or any combination thereof, for example.

Modifying substances, such as, but not limited to, diamond, diamond-like, boron, beryllium, and carbon-based constituents, for example, may be grown in and/or on electrodes for enhancing nuclear reactions. The modifying substances may trap and stimulate various forms of hydrogen for useful energy producing reactions. Various techniques can be used to accomplish this goal, including: (1) chemical vapor deposition (CVD) and its many forms and derivatives; (2) LASER techniques and similar methods; (3) plasma techniques; (4) ion implantation; and (5) similar hot-gas methods of producing diamond, diamond-like structures, and carbon-based constituents on and/or in electrodes. Diamond and diamond-like constituents exist in many forms and combinations as defined by analytical techniques, such as X-ray diffraction, Raman spectroscopy, and low energy electron diffraction (LEED), for example. Carbon-based constituents, such as nanotubes, graphitic carbon, and other carbon forms are also suitable constituents for enhancing nuclear reactions induced by various forms of hydrogen.

An other significant feature of the invention which distinguishes it from prior cells in which the current through the electrolyte is pulsed, is that in a cell in accordance with the invention, pulsing may take place in a pulse pattern that increases the probability of LENR to occur and, hence, the level of reproducibility. More specifically, an object of the invention is to provide a low energy nuclear reaction power generator that yields far more energy in the form of heat than is applied to the cell in the form of electricity.

Briefly stated, this object is attained in a low energy nuclear reaction power generator provided with an electrochemical cell. The electrochemical cell contains an electrode pair whose cathode is formed of any conductive material, such as metal, alloy, cermet, conductive polymer, composite, or any combination thereof, such as metal (e.g., platinum, palladium, titanium, nickel, gold, silver, tin, lead, tungsten, thorium, uranium, etc.), any suitable metal alloys (e.g., Pd—Ce, Pd—B, Pd—Ni, etc.), or any suitable non-metallic substrate (e.g., SiO₂, SiC, TiO₂, TiC, Al₂O₃, Y₂O₃, etc.), plated with a suitable metallic film. Diamond, diamond-like constituents, carbon, boron, and/or beryllium-based constituents, for example, are preferably embedded in and/or on the surfaces of the cathodes for enhancing nuclear reactions of the generator.

The cell also preferably contains an electrically-conductive electrolyte, which may be any suitable fluid (e.g., light water, heavy water, etc.) mixed with suitable solutes (e.g., LiOD, CaSO₄, Li₂SO₄, etc.), molten salts (e.g., LiCl—KCl saturated with LiD, etc.), liquid metals (e.g., liquid Pb saturated with PbD₂ or Pb(OD)₂, etc.), and/or any suitable solid material (e.g., a solid conductor). Applied across the electrodes is preferably a train of voltage pulse packets, each comprised of a cluster of pulses.

The amplitude and duration (or alternatively, frequency) of each pulse in the packet, the duration of the intervals between pulses, and the duration of the intervals between successive packets in the train are in a predetermined pattern in accordance with “superwaving” waves, in which each wave is modulated by waves of different amplitude and duration. Each packet of voltage or current pulses gives rise to enhanced loading of the palladium cathode, for example, followed by partial deloading. The successive enhanced loading and partial deloading produced by the train of pulse packets enhance the interaction between the nuclei of these hydrogenous atoms themselves and/or between the nuclei of these hydrogenous atoms and the nuclei of the electrode material. The energy generated in the form of heat is greater than the electrical energy of the pulses applied to the electrodes.

It should be noted that dense atom-packing may substantially change the resistance (i.e., the measure of a material's ability to resist the flow of an electric current) of a metallic cathode by introducing various forms of hydrogen or other atoms to the structure of the metal. This resistance preferably can be measured in real-time by passing a constant high frequency current through the metallic electrode and measuring the voltage potential across the cathode over time. The measured voltage potential over time is an indication of the change in resistance, and, hence, the level of ion packing of the metallic electrode over time. Thus, a real-time indicator of the atom-packing may then be realized by continually passing a high frequency current through the metallic electrode and measuring the voltage potential across the cathode.

### BRIEF DESCRIPTION OF THE DRAWINGS

The above and other advantages of the invention will be more apparent upon consideration of the following detailed description, taken in conjunction with the accompanying drawings, in which like reference characters refer to like parts throughout, and in which:

FIGS. 1 and 1A schematically illustrate superwaving wave phenomena;

FIG. 2 schematically illustrates a partially sectional perspective view of a first embodiment of an electrolytic cell LENR power generator in accordance with the invention;

FIG. 3 illustrates the pattern of electrical pulses applied to the electrodes of the cell of FIG. 2; and

FIG. 4 illustrates the pattern of electrical pulses applied to the electrodes of the cell of FIG. 2 with pulse packets switched off during relaxation periods.

### DETAILED DESCRIPTION OF THE INVENTION

Superwaving:

Some embodiments of the invention provide for a greater production of excess heat in an electrochemical cell by pulsing the current flowing through the cell. In the invention, applied to the electrodes of the cell may be voltage or current (electrical) pulses to produce a pulsed ion-flow in the cell. However, these pulses may be in a pattern in which the amplitude and duration of the pulses and the intervals therebetween are modulated to give rise to a dense packing, for example, of deuterium atoms in the palladium electrode that promotes LENR, rather than being of constant amplitude and duration.

This pulse pattern is in accordance with superwaving activity as set forth in the theory advanced in the Irving I. Dardik article “The Great Law of the Universe” that appeared in the March/April 1994 issue of the “Cycles” Journal. This article is incorporated herein by reference.

As pointed out in the Dardik article, it is generally accepted in science that all things in nature are composed of atoms that move around in perpetual motion, the atoms attracting each other when they are a little distance apart and repelling upon being squeezed into one another. In contradistinction, the Dardik hypothesis is that all things in the universe are composed of waves that wave, this activity being referred to as “superwaving.” Superwaving gives rise to and is matter in motion (i.e., both change simultaneously to define matter-space-time).

Thus in nature, changes in the frequency and amplitude of a wave are not independent and different from one another, but are concurrently one and the same, representing two different hierarchical levels simultaneously. Any increase in wave frequency at the same time creates a new wave pattern, for all waves incorporate therein smaller waves and varying frequencies, and one cannot exist without the other.

Every wave necessarily incorporates smaller waves, and is contained by larger waves. Thus each high-amplitude low-frequency major wave is modulated by many higher frequency low-amplitude minor waves. Superwaving is an ongoing process of waves waving within one another.

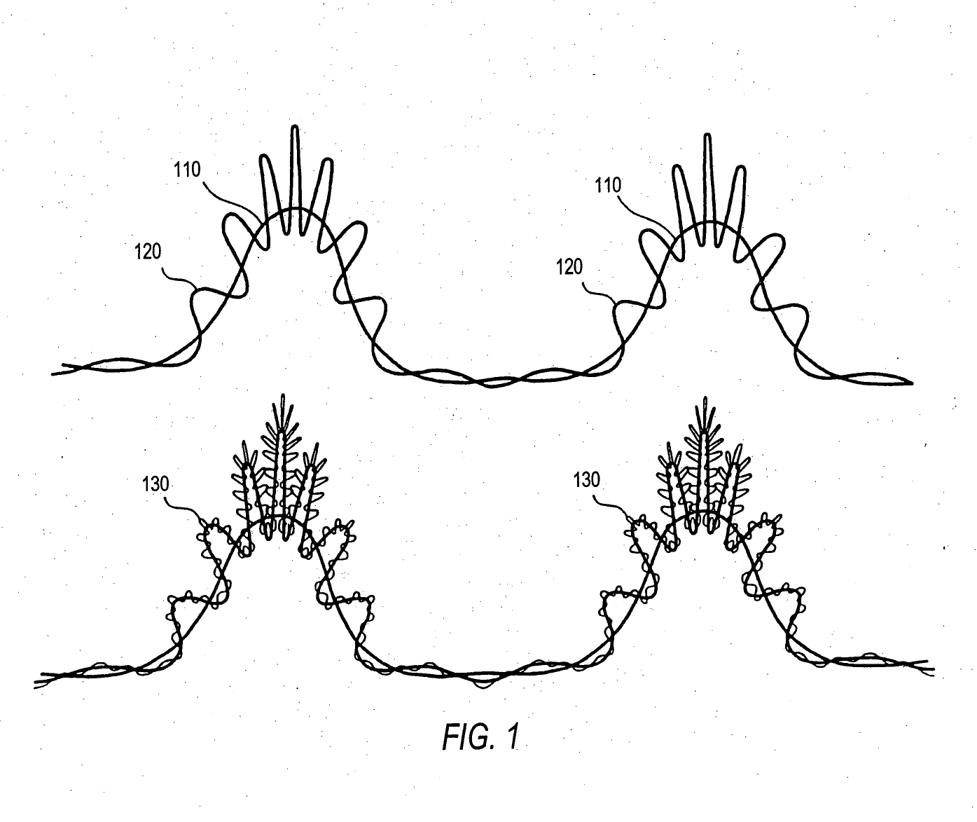

FIG. 1 (adapted from the illustrations in the Dardik article) schematically illustrates superwaving wave phenomena. FIG. 1 depicts low-frequency major wave 110 modulated, for example, by minor waves 120 and 130. Minor waves 120 and 130 have progressively higher frequencies (compared to major wave 110). Other minor waves of even higher frequency may modulate major wave 110, but are not shown for clarity. This same superwaving wave phenomena is depicted in the time-domain in FIG. 1A.

This principle of waves waving demonstrates that wave frequency and wave intensity (amplitude squared) are simultaneous and continuous. The two different kinds of energy (i.e., energy carried by the waves that is proportional to their frequency, and energy proportional to their intensity) are also simultaneous and continuous. Energy therefore is waves waving, or “wave/energy.” In a low energy nuclear reaction power generator in accordance with one embodiment of the invention, the pattern of pulses applied to the electrodes of the cell is derived from superwaving wave activity.

The Electrolytic Cell:

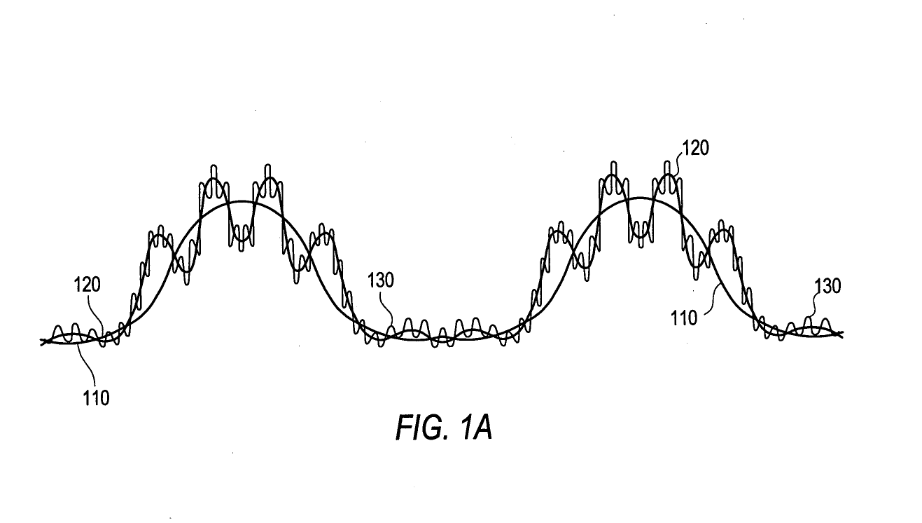

Referring now to FIG. 2, there is shown a preferred embodiment of a low energy nuclear reaction power generator 100 in accordance with the invention provided with an electrolytic cell. The cell is provided with a vessel 10. Vessel 10 contains electrolyte 11. Electrolyte 11 may be any suitable liquid electrolyte, such as heavy water or light water mixed with suitable solutes (e.g., LiOD, D₂SO₄, Li₂SO₄, etc.), for example. For purposes of illustration, electrolyte 11 may be heavy water which is rendered electrically conductive by a suitable solute dissolved therein (e.g., LiOD).

Immersed in the electrolyte is an anode-cathode electrode pair formed by a cathode 12 and an anode 13. Cathode 12 and anode 13 may be made of any conductive material, such as metal (e.g., palladium, platinum, titanium, nickel, etc.), any suitable non-metallic substrate plated by suitable metallic film (e.g., palladium or titanium on sapphire, etc.), alloy, cermet, conductive polymer, composite or any combination thereof, for example. Electrodes 12 and 13 may be of homogeneous material or nonhomogeneous material, such as a material layered, coated, or laced with particles. Electrodes 12 and 13 may be shaped as plates, strips, wires, spheres, squares, or any combination thereof, for example.

For purposes of illustration, however, cathode 12 may be a strip or wire made of palladium and anode 13 may be a coil or plate of platinum. Anode coil 13 surrounds or may be mounted parallel to the strip or wire of palladium metal so that the electrodes are bridged by the conductive electrolyte 11 and so that a voltage impressed across the electrodes causes a current to flow therebetween.

Connected across the electrodes of the electrochemical cell may be a d-c power supply, resulting in a steady current flowing through the electrolyte, causing it to dissociate, so that oxygen gas is liberated at the platinum anode electrode, while hydrogenous ions migrate towards the palladium cathode electrode and partially accumulate thereon; the other part is liberated at the cathode as hydrogen gas.

In a generator in accordance with a preferred embodiment of the invention, a d-c voltage or current source 14 may be provided whose electrical output is applied across the electrodes 12 and 13 of the cell through an electronic modulator 15. The operation of modulator 15 may be controlled by a programmed computer 16, whereby the modulator yields voltage or current pulses whose amplitude and duration, as well as the duration of the intervals between pulses, are determined by the program. The maximum amplitude of the pulses may correspond to the full output of the d-c source 14. Thus, if the source provides a 45 VDC output, the maximum amplitude of the pulses may be 45 VDC, and the amplitudes of pulses having a lesser amplitude may be below 45 VDC, depending on the program.

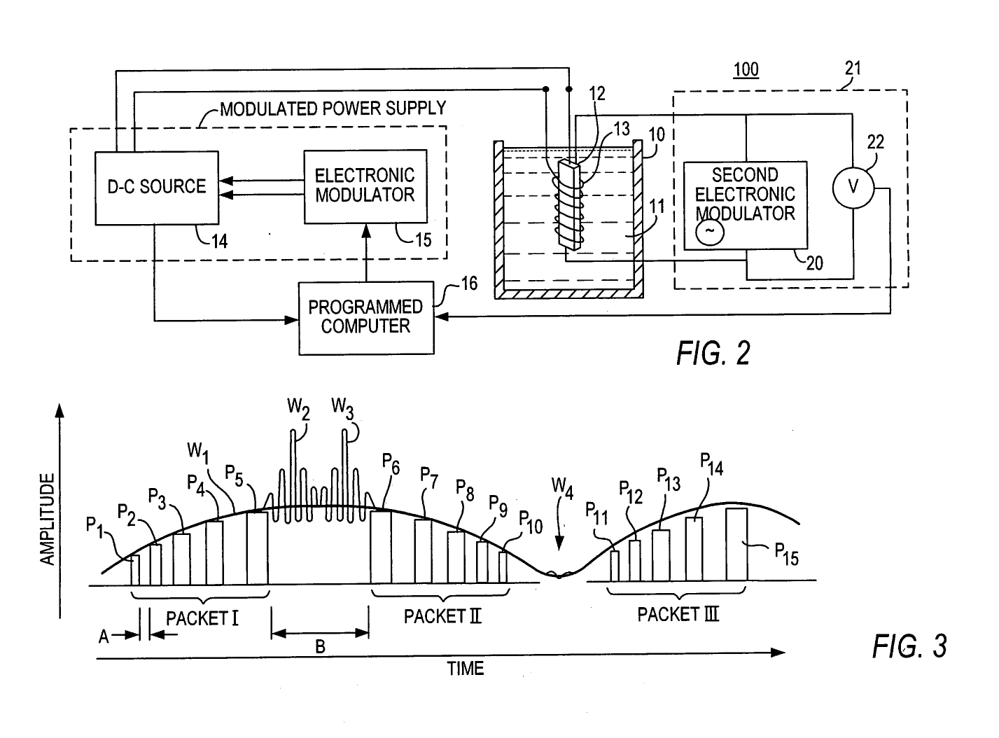

Computer 16 may be programmed to activate electronic modulator 15 so as to yield a train of pulse packets, each packet being formed by a cluster of pulses that assume the pattern shown in FIG. 3. Thus, for example, the first packet in the train, packet I, is composed of five pulses P₁ to P₅ which progressively vary in amplitude, pulse P₁ being of the lowest amplitude and pulse P₅ being of the highest amplitude. The respective durations of pulses P₁ to P₅ vary progressively so that pulse P₁ is of the shortest duration and pulse P₅ is of the longest duration, and so that the intervals A between successive pulses in the cluster forming the packet vary progressively in duration. Thus, the first interval between pulses P₁ and P₂ is shortest in duration, and the last interval between pulses P₄ and P₅ is longest in duration. While the packets are shown as being composed of five pulses, in practice they may have a fewer or a greater number of pulses. The duration of a packet may, for example, be about 30 seconds, and the intervals between successive packets may, for example, be in a range of 2-5 seconds.

The second packet in the train, packet II, is also composed of five pulses P₆ to P₁₀, but their amplitudes and durations, and the intervals between pulses, are the reverse of those in the pulse cluster of packet I. Hence, pulse P₆ is of the greatest amplitude and that of P₁₀ is of the lowest amplitude.

The third packet in the train, packet III, is formed of a cluster of five pulses P₁₁ to P₁₅ whose amplitudes and durations, and the intervals between pulses, correspond to those in packet I. The intervals between successive packets in the train have a duration B that changes from packet to packet.

The varying amplitudes of the pulses in the successive packets conform to the amplitude envelope of a major wave W₁. The varying durations of the pulses in the packets conform to the amplitude envelope of a minor wave W₂ whose frequency differs from that of major wave W₁. The varying durations of the intervals between the pulses in a packet conforms to the amplitude envelope of still another minor wave W₃ of different frequency. And the varying durations of the intervals between successive packets in the train are in accordance with the amplitude envelope of yet another minor wave W₄ of different frequency.

It will be understood that in FIG. 3, for purposes of clarity, only small portions of minor waves W₂, W₃, and W₄ superimposed on wave W₁ are shown. Furthermore, for clarity, the amplitudes and frequencies of superwaving minor waves W₂, W₃, and W₄, relative to each other and relative to major wave W₁, are not drawn to scale. In fact the maximum amplitude of the minor waves may be proportional to the instantaneous amplitude of the major wave. Thus, minor waves W₂ and W₃ (which are located at about the peak amplitude of major wave W₁) are likely to have much larger maximum amplitudes than the maximum amplitude of minor wave W₄ (which is located at about the bottom of a valley of wave W₁). The maximum amplitude of minor waves W₂ and W₃ at the peak of the major wave may even be comparable to the peak amplitude of major wave W₁, (i.e., the minor waves may have the same or greater intensity as the major waves as shown in FIG. 1). Other illustrative examples of superwaving minor waves within major waves and their frequency and amplitude distribution are provided by the FIGS. shown in the Dardik article “The Great Law of the Universe” incorporated herein by reference.

With continued reference to FIG. 3, the pattern of the voltage or current (electrical) pulses which constitute the train is governed by superwaving waves W₁ to W₄ and the ions which flow between the electrodes immersed in the electrolyte are pulsed accordingly.

Thus, instead of a steady stream of deuterium ions migrating toward the palladium electrode, the deuterium ions travel in clusters, each created by a packet of pulses, to produce a high intensity surge of deuterium ions that bombards the palladium electrode. The surges of deuterium ions which repeatedly bombard the palladium electrode give rise to a dense packing of the deuterium atoms in the palladium which creates LENR heat.

In a generator in accordance with the invention, a resistance meter (LCR) 21, which may include a second modulator 20 and a voltmeter 22, may be implemented in order to measure the resistance of cathode 12. This measurement may then be used to indicate the level of deuterium atom-packing of the cathode.

Highly effective computer pulse pattern programs afford optimum results, resulting in the greatest amount of nuclear reaction heat at the palladium electrode. These can be determined empirically by modifying the program of computer 16 to find the most effective pattern and by modifying the program to be responsive to the resistance of the cathode measured by LCR 21. In one example of a method according to the invention, the change in resistance may be used to modify the modulating in order to maximize the atom-packing. A feedback signal representing the slope of the resistance, for example, may be used to optimize the relationship between any of the waves with respect to any of the other waves, the respective frequencies of the individual waves, the respective amplitudes of the individual waves, or any other suitable parameter.

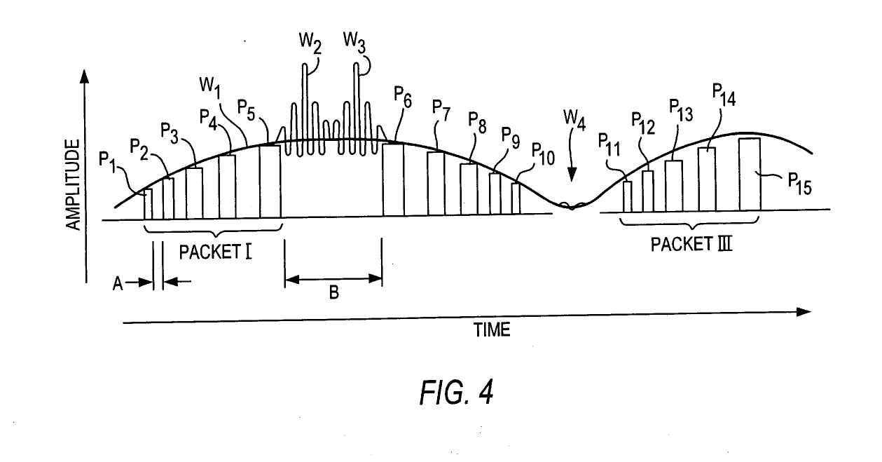

One example of the most effective pulse pattern is to incorporate a relaxation period corresponding to the downward phases of the major wave W₁. Pulse packets in the pulse train may be completely turned off during the relaxation periods corresponding to the downward phases. FIG. 4 illustrates a pulse pattern with pulses (e.g., pulses of packet II, FIG. 3) completely switched off during the relaxation period.

The program is developed from a formation of superwaving waves which are digitized so as to derive a pulse at the peak of each wave cycle. The aforementioned Dardik article illustrates various forms of superwaving waves.

Modified Electrodes:

As described above, the electrodes of the invention may be any conductive material such as metal, alloy, cermet, conductive polymer, composite or any combination thereof, for example. The electrodes may be of homogeneous material or nonhomogeneous material, such as a material layered, coated, or laced with particles. The electrodes may be shaped as plates, strips, wires, spheres, squares, or any combination thereof, for example.

In various embodiments of the invention, Modifying substances, such as, but not limited to, diamond, diamond-like, boron, beryllium, and carbon-based constituents, for example, may be grown in and/or on electrodes for enhancing nuclear reactions. The modifying substances may trap and stimulate various forms of hydrogen for useful energy producing reactions. Various techniques can be used to accomplish this goal, including: (1) chemical vapor deposition (CVD) and its many forms and derivatives; (2) LASER techniques and similar methods; (3) plasma techniques; (4) ion implantation; and (5) similar hot-gas methods of producing diamond, diamond-like structures, and carbon-based constituents on and in electrodes. Diamond and diamond-like constituents exist in many forms and combinations as defined by analytical techniques, such as X-ray diffraction, Raman spectroscopy, and low energy electron diffraction (LEED), for example. Carbon-based constituents, such as nanotubes, graphitic carbon, and other carbons forms are also suitable constituents for enhancing nuclear reactions induced by various forms of hydrogen.

Diamond nucleation and growth on palladium cathodes, for example, for producing strong centers for atomic interstitial traps (e.g., H, N, C, B, Be, O etc.) and both long and short range internal strain, are described herein for improving low energy nuclear reactions. Once again, as an example, plasma-assisted CVD used with palladium may produce a palladium electrode that contains diamonds, diamond-like, and/or carbon-based constituents in and/or on the surface of the electrode. Using this technique, metals, alloys, composites, and other materials, preferably included in cathode 12, can be made to act as a host to diamond and diamond-like constituents, for example. It may also act as a host to carbon, boron, or beryllium constituents, for example.

In addition to carbon and its various forms, other interstitial elements and gas-phase elements may also be suitable modifying substances for attracting, trapping, and/or converting hydrogen in electrodes. These include, for example, helium, lithium, beryllium, boron, nitrogen, oxygen, fluorine, neon, sodium, potassium, phosphorus, sulfur, chlorine, argon, bromine, krypton, iodine, and xenon. The boron-hydrogen combination shows particularly strong potential for promoting useful hydrogen reactions in electrodes. As carbon-boron interactions are known for their strong interaction and useful behaviors, binary combinations such as carbon-boron and carbon-nitrogen can be particularly useful in the hydrogen reactions in electrodes. Furthermore, many binary and ternary combinations are useful as one or more modifying substances and can have a strong effect on hydrogen and its beneficial behavior in electrodes. One such ternary combination that can be used as a modifying substance according to the invention with useful interaction is carbon-boron-nitride. Any combination of the interstitial and gas phase elements already identified are potential candidates for binary, ternary, and higher order interactions of a useful nature as a modifying substance.

Furthermore, a wide range of elements are extremely useful in stimulating hydrogen interaction internally and/or on the surface of electrodes of the invention. Much is known about the H—C, hydrocarbon, series of chemical interactions. However, many elements produce a range of interesting and useful reactions with hydrogen. These types of modifying substances can be identified and organized in the notation of hydride forms as follows, for example:
Mononuclear parent hydrides, such as:
   Groups 13, such as:
      BH3—borane
      AlH3—alumane
      InH3—indigane
      GaH3—gallane
      TlH3—thallane
   Groups 14, such as:
      CH4—methane
      SiH4—silane
      GeH4—germane
      SnH4—stannane
      PbH4—plumbane
   Groups 15, such as:
      NH3—azane
      PH3—phosphane
      AsH3—arsane
      SbH3—stibane
      BiH3—bismuthane
   Groups 16, such as:
      OH2—oxidane
      SH2—sulfane
      SeH2—selane
      TeH2—tellane
      PoH2—polane
   Groups 17, such as:
      FH—fluorane
      ClH—chlorane
      BrH—bromane
      IH—iodane
      HAt—astatane
Acyclic polynuclear parent hydrides, such as:
   Acyclic hydrocarbons, such as:
      C2H6
      CH3-CH2-
   Acyclic non-hydrocarbons, such as:
      NH2-
      SiH3-
      PH2-
   Heterogeneous parent hydrides, such as:
      SnH3-O—
      SiH3-NH—
      SH—S—
Monocyclic parent hydrides, such as:
   Hydrocarbons, such as:
      Cyclopropane
      Cyclohexane
      Cyclotetradecane
   Heteromonocyclic parent hydrides, such as:
      Furan
      Imidazole
      Isothiazole 1,2-thiazole
      Isoxazole 1,2-oxazole
      1H-azirine
      Oxirene
      Oxazirene
Polyalicyclic (von Baeyer) systems
Spiro compounds
Fused and bridged fused ring systems
Phane nomenclature
Fullerenes
Ring assemblies

The stability/destability of the aforementioned elements, compounds, and reactions relating to hydrogen and its hydrides can be significantly modified by metallurgical and mechanical alloying of the electrode with various elements and compounds, according to the invention. For example, nickel can be alloyed with palladium to change the internal thermodynamic characteristics of palladium and, hence, modify the hydrogen reactivity with the elements thus mentioned. It is also known that any element or combination of elements alloyed with palladium or various other electrode materials will change the thermodynamic behavior of that material relative to its reactivity with hydrogen. Thus, the electrode material and all of its various thermodynamic combinations with other elements, either chemical or mechanical, can be individually combined with the hydrides, and hydrogen-elemental combinations proposed, in accordance with the invention.

The mechanical state of the electrode relative to its internal and external stress and strain also affects the electrode's response to hydrogen activity. Thus, given all the various chemical combinations identified, each of these combinations can be individually controlled further by the application of internal and external mechanically induced stress and strain. Examples of internal stress and strain are residual stress and strain from mechanical operations, such as cold rolling, cold forming, shot peening, ball milling and ultrasonic cleaning. Residual stress and strain can also result from gradients in the material, such as a temperature gradient and the resulting gradient in thermal expansion. A typical process resulting in residual internal stress and strain due to thermal expansion and contraction is welding.

External stress and strain can also affect the activity of the hydrogen reaction with surface and internally placed modifying substances, such as carbon, boron, nitrogen, CB, and CBN, for example. Examples of the source of the external stress and strain are devices which stretch, compress, bend, torque, and shear the material during the operation of the electrode in service.

Elements which can be added to the electrodes of the invention as modifying substances for special effect include both gases (e.g., argon, helium, hydrogen, nitrogen, oxygen, etc., which may be the feed gas or constituents to a feed gas of a CVD reaction) and non-gases (e.g., boron, beryllium, etc., which may be incorporated into the plasma gas by solid constituents in or in close proximity to the plasma). Thus, in accordance with the invention, it is possible to produce an electrode with a variety of carbon-based constituents that are combined with any of a number of elements suited for delivery through CVD, plasma, hot gas, electron bombardment, LASER, and other methods, for example.

It is proposed that the constituents and elements identified herein can be produced in any configuration, shape, or material, for example, such that it may be used as an electrode for producing energy in an electrode-electrolyte cell, such as generator 100.

In certain conditions, it may be necessary to create a low energy nuclear reaction in such a generator by deuterium loading of an electrode with material defects. The nucleation of a diamond or diamond-like crystallite on and/or below the surface of an electrode of the invention preferably produces the sort of defects (i.e., lattice vacancies) needed for the improved low energy nuclear reaction effect. Diamonds preferably are grown on the face centered cubic (FCC) metal octahedral interstices of the electrode as points of vacancy initiation.

In one embodiment of the invention, in-situ diamond, diamond-like, and carbon-based constituents are deposited into the structure of an electrode (e.g., palladium cathode 13) and/or onto its surface. To this new structure, nitrogen and hydrogen may also be added through the method of plasma-assisted CVD, for example. X-ray diffraction and Raman spectroscopy may be used to verify that the modifying substances previously identified are produced in this electrode.

A metal deuteride containing helium may be constructed so as to maximize the internal molecular deuterium density. It may be stimulated to develop one or more highly excited phonon modes in order to cause deuterium to react to produce low energy nuclear reactions as described above. In a preferred embodiment of the invention, the newly understood reaction pathways are used to make energy using deuterium reactions that couple the reaction energy directly into the phonon modes of the metal deuteride. The energy generation may be a result of the performance and then attainment of lattice-mediated nuclear reactions using deuterium and deuterium-helium combinations.

In certain embodiments of the invention, (4He) may be introduced into the host lattice. Methods of obtaining the desired 4He concentration may include high temperature diffusion or helium-ion implantation, for example. In one embodiment, deuterium may be loaded into a host lattice by electrochemical reduction of heavy water (D₂O) or deuterated alcohol (e.g., CD₃0D, CH₃0D, C₂D₅D, C₂HSOD, etc.) at an electrode of the invention (e.g., cathode 13), for example. The appropriate lattice phonon modes, in their role of initiating, stimulating, or triggering the low energy nuclear reactions, may be generated by causing deuterium atoms (D) to flow across a steep gradient in chemical potential, such as that present at the palladium/diamond embedded interface. Thus, in an other embodiment of the invention, the modifying substances may stimulate phonon generation from the absorbing deuteron flux.

While hydrogen (H₂) and methane (CH₄) may be used in certain diamond growth processes, this may result in loading hydrogen atoms (H) into the palladium metal bulk. Therefore, it may be preferable for the preferred absorption and trapping sites to be the ones that deuterium atoms must occupy to produce low energy nuclear reactions. Energetically, and because of the lattice stain introduced by the sub-surface diamond layer, it is sometimes difficult to remove an H atom introduced in the diamond growth so that it can be replaced with a D atom. In certain preferred embodiments of the invention, instead of growing the diamonds in H₂ and CH₄, heavy forms (e.g., D₂ and CD₄) are preferably used. In this way, D atoms may be loaded into the palladium lattice first, and then the loading may be sealed with the diamond layer.

In addition to H and D atoms, beryllium (Be)—, boron (B)—, and carbon (C)-based constituents, for example, are all capable of occupying the octahedral interstitial sites in the electrode (e.g., palladium cathode 13), and of diffusing between the sites (and, thus, into the metal), as modifying substances. Beryllium and boron may also form metallic cluster nuclei that can have similar beneficial effects to the diamond crystallites. Along with diamond, diamond-like, and carbon-based constituents, beryllium- and boron-based constituents diffusing into electrodes undergoing (heavy) aqueous electrolysis are very beneficial in providing low energy nuclear reactions.

While there have been described preferred embodiments of low energy nuclear reaction power generators, it is to be understood that many changes may be made therein without departing from the spirit and scope of the invention. Thus, one may use silicon instead of platinum as the anode of an electrolytic cell, for example. Moreover, an electrode pair may be formed by concentric tubes, rather than by a strip surrounded by a coil as illustrated in the electrolytic cell of FIG. 2, for example. Furthermore, the cell for producing energy may be an ion acceleration cell LENR power generator containing an electrode pair and an electrically-conductive ionized gas, rather than a pair of electrodes immersed in an electrically conductive electrolyte. Alternatively, the cell for producing energy may be a high pressure electrolytic ultrasonic cell LENR power generator containing an electrode loaded under various pressures and temperatures that is immersed in an electrolyte and, in certain embodiments, stimulated by ultrasonic waves and ultrasonically-induced cavitations. One skilled in the art will appreciate that the invention can be practiced by other than the described embodiments, which are presented for purposes of illustration and not of limitation, and the invention is only limited by the claims which follow.

What is claimed is:

1. An apparatus for generating a low energy nuclear reaction involving a material and hydrogenous atoms, the apparatus comprising:
a low energy nuclear reaction cell containing an electrically conductive electrolyte having enveloped therein an anode-cathode electrode pair, said cathode electrode being formed of said material;
a power supply that is adapted to apply an electrical output across said electrode pair to cause a corresponding current to flow between said electrode pair, thereby causing said electrolyte to dissociate, whereby oxygen is released at said anode electrode while said hydrogenous atoms migrate into said cathode electrode, wherein at least one modifying substance is grown at least one of into and on said material of said cathode electrode for enhancing the interaction between said material and said hydrogenous atoms.

2. The apparatus of claim 1, wherein said at least one modifying substance includes diamond-based constituents.

3. The apparatus of claim 1, wherein said at least one modifying substance includes carbon-based constituents.

4. The apparatus of claim 1, wherein said at least one modifying substance includes boron-based constituents.

5. The apparatus of claim 1, wherein said at least one modifying substance includes beryllium-based constituents.

6. The apparatus of claim 1, wherein said at least one modifying substance is grown at least one of into and on said material by chemical vapor deposition.

7. The apparatus of claim 1, wherein said at least one modifying substance is grown at least one of into and on said material by a laser technique.

8. The apparatus of claim 1, wherein said at least one modifying substance is grown at least one of into and on said material by a plasma technique.

9. The apparatus of claim 1, wherein said at least one modifying substance is grown at least one of into and on said material by ion implantation.

10. The apparatus of claim 1, wherein said at least one modifying substance is grown at least one of into and on said material by high temperature diffusion.

11. The apparatus of claim 1, wherein said at least one modifying substance is grown at least one of into and on said material by a hot-gas technique.

12. The apparatus of claim 1, wherein said at least one modifying substance is grown at least one of into and on said material by electron bombardment.

13. The apparatus of claim 1, wherein said electrical output is a train of pulsed electrical packets, a cluster of pulses being superimposed on each of said packets, to cause a correspondingly pulsed current to flow between said electrode pair, each of said packets of pulses producing a surge of said hydrogenous atoms which are forced into said cathode electrode, successive surges producing a dense packing of said hydrogenous atoms in said cathode electrode, and wherein each pulse in said cluster of pulses has an amplitude that is proportional to an instantaneous amplitude of a major wave associated with said train of pulsed electrical packets, and wherein each pulse in said cluster of pulses has a frequency that is proportional to an instantaneous frequency of said major wave associated with said train of pulsed electrical packets.

14. A method for generating a low energy nuclear reaction involving a material and hydrogenous atoms, the method being implemented on a low energy nuclear reaction cell containing an electrically conductive electrolyte having enveloped therein an anode-cathode electrode pair, said cathode electrode being formed of said material, the method comprising:
applying an electrical output across said electrode pair to cause a corresponding current to flow between said electrode pair, thereby causing said electrolyte to dissociate, whereby oxygen is released at said anode electrode while said hydrogenous atoms migrate into said cathode electrode; and
prior to said applying, depositing at least one modifying substance at least one of into and on said material of said cathode electrode for enhancing the interaction between said material and said hydrogenous atoms.

15. The method of claim 14, wherein said at least one modifying substance includes diamond-based constituents.

16. The method of claim 14, wherein said at least one modifying substance includes carbon-based constituents.

17. The method of claim 14, wherein said at least one modifying substance includes boron-based constituents.

18. The method of claim 14, wherein said at least one modifying substance includes beryllium-based constituents.

19. The method of claim 14, wherein said depositing comprises chemical vapor deposition.

20. The method of claim 14, wherein said depositing comprises a laser technique.

21. The method of claim 14, wherein said depositing comprises a plasma technique.

22. The method of claim 14, wherein said depositing comprises ion implantation.

23. The method of claim 14, wherein said depositing comprises high temperature diffusion.

24. The method of claim 14, wherein said depositing comprises a hot-gas technique.

25. The method of claim 14, wherein said depositing comprises electron bombardment.

26. The method of claim 14, wherein said electrical output is a train of pulsed electrical packets, a cluster of pulses being superimposed on each of said packets, to cause a correspondingly pulsed current to flow between said electrode pair, each of said packets of pulses producing a surge of said hydrogenous atoms which are forced into said cathode electrode, successive surges producing a dense packing of said hydrogenous atoms in said cathode electrode, and wherein each pulse in said cluster of pulses has an amplitude that is proportional to an instantaneous amplitude of a major wave associated with said train of pulsed electrical packets, and wherein each pulse in said cluster of pulses has a frequency that is proportional to an instantaneous frequency of said major wave associated with said train of pulsed electrical packets.
